(19) United States
(12) Patent Application Publication
(10) Pub. No.: US 2025/0133990 A1
(43) Pub. Date: May 1, 2025

(54) SYSTEMS AND METHODS FOR AUTOMATICALLY CONTROLLING THE OPERATION OF A COTTON HARVESTER AND RELATED HARVESTERS

(71) Applicant: CNH Industrial America LLC, New Holland, PA (US)

(72) Inventors: Bart M.A. Missotten, II, Herent (BE); Thomas Mahieu, Vleteren (BE)

(21) Appl. No.: 18/692,303

(22) PCT Filed: Sep. 14, 2022
(86) PCT No.: PCT/US22/43441

§ 371 Date: Mar. 14, 2024

Related U.S. Application Data
(60) Provisional application No. 63/243,935, filed on Sep. 14, 2021.

(51) Int. Cl. A01D 46/08

(52) U.S. Cl. CPC A01D 46/085

(57) ABSTRACT

In one aspect, a cotton harvester includes a harvesting implement configured to harvest materials from a field. The harvested materials include both cotton and material other than cotton (MOC). The harvester also includes a material processing system configured to receive the harvested materials from the harvesting implement, with the harvested materials being directed through the material processing system along a material transfer path. Additionally, the harvester includes a sensor configured to generate data indicative of an amount of MOC contained within the harvested materials at a location along the material transfer path, and a computing system communicatively coupled to the sensor. The computing system is configured to adjust an operational setting of the cotton harvester based at least in part on the amount of MOC contained within the harvested materials.

### FIELD OF THE INVENTION

The present subject matter relates generally to cotton harvesters, and, more particularly, to systems and methods for automatically controlling the operation of cotton harvesters.

### BACKGROUND OF THE INVENTION

Cotton harvesters typically include a header or harvesting implement including one or more row units for harvesting cotton from a field. Depending on the type of harvester, the row units may be provided in differing configurations. For instance, with picker-type cotton harvesters, the row units (or picking units) of the harvesting implement typically include one or more picking drums having rotating spindles that pick cotton from the cotton bolls for subsequent processing. In contrast, with stripper-type cotton harvesters, the row units (or picking units) of the harvesting implement typically include one or more pairs of counter-rotating stripper drums having bats/brushes that strip cotton and other plant material from the cotton plants for further processing.

Conventionally, the operation of a cotton harvester requires substantial operational involvement and control by the operator. For example, the operator is typically required to control various operating parameters, such as the direction and speed of the harvester, the aggressiveness of the harvesting implement, the settings of the related cleaning sub-systems, and/or the like. Such manual operation can often be quite cumbersome and requires an operator with significant skill and expertise to effectively efficiently operate the harvester.

Accordingly, systems and methods for automatically controlling the operation of a cotton harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a cotton harvester including a harvesting implement configured to harvest materials from a field. The harvested materials include both cotton and material other than cotton (MOC). The harvester also includes a material processing system configured to receive the harvested materials from the harvesting implement, with the harvested materials being directed through the material processing system along a material transfer path. Additionally, the harvester includes a sensor configured to generate data indicative of an amount of MOC contained within the harvested materials at a location along the material transfer path, and a computing system communicatively coupled to the sensor. The computing system is configured to adjust an operational setting of the cotton harvester based at least in part on the amount of MOC contained within the harvested materials.

In another aspect, the present subject matter is directed to a system for automatically controlling the operation of a cotton harvester. The system includes a harvesting implement configured to harvest materials from a field, and a material processing system configured to receive the harvested materials from the harvesting implement, with the harvested materials being directed through the material processing system along a material transfer path. The system also includes an imaging device configured to capture an image of the harvested materials at a location along the material transfer path, and a computing system communicatively coupled to the imaging device. The computing system is configured to determine a quality-related metric associated with the harvested materials based at least in part on the captured image.

In a further aspect, the present subject matter is directed to a method for automatically controlling the operation of a cotton harvester. The cotton harvester includes a harvesting implement configured to harvest materials from a field, with the harvested materials including both cotton and material other than cotton (MOC). The method includes receiving, with a computing system, data indicative of an amount of MOC contained within the harvested materials, and adjusting, with the computing system, an operational setting of the cotton harvester based at least in part on the amount of MOC contained within the harvested materials.

In yet another aspect, the present subject matter is directed to a method for automatically controlling the operation of a cotton harvester. The cotton harvester includes a harvesting implement configured to harvest materials from a field. The method includes receiving, with a computing system, an image(s) of the harvested materials at a location along a material transfer path of the cotton harvester, and determining, with the computing system, a quality-related metric associated with the harvested materials based at least in part on the image(s).

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of a cotton harvester in accordance with aspects of the present subject matter, particularly illustrating the harvester including components of one embodiment of a system for automatically controlling the operation of the harvester;

FIG. 2 illustrates a simplified, side view of another embodiment of a cotton harvester in accordance with aspects of the present subject matter, particularly illustrating the harvester including components of one embodiment of a system for automatically controlling the operation of the harvester;

FIG. 3 illustrates a schematic view of one embodiment of components configured for use within a system for automatically controlling the operation of a cotton harvester in accordance with aspects of the present subject matter;

FIG. 4 illustrates a flow diagram of one embodiment of a method for automatically controlling the operation of a cotton harvester in accordance with aspects of the present subject matter; and

FIG. 5 illustrates a flow diagram of another embodiment of a method for automatically controlling the operation of a cotton harvester in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for automatically controlling the operation of a cotton harvester. Specifically, in several embodiments, the disclosed system includes one or more sensors configured to generate data associated with one or more harvest-related metrics or parameters for the cotton harvester. For instance, in one embodiment, the system may include one or more loss sensors configured to generate data associated with harvest losses, such as the amount of cotton remaining within the field post-harvest and/or the amount of cotton existing on the cotton plants pre-harvest. Additionally, in one embodiment, the system may include one or more quality sensors configured to generate data associated with the quality of the materials harvested by the harvester, such as by generating data associated with the amount of “material other than cotton” or “MOC” _contained within the harvested materials, the color of the harvested cotton, the presence of insect/fungal damage, the fiber thickness or micronaire of the cotton, and/or the like.

Additionally, in accordance with aspects of the present subject matter, the sensor(s) may be communicatively coupled to a computing system that is configured to executed one or more control actions in response to the data received from the sensor(s). For instance, in several embodiments, the computing system may be configured to automatically control the operation of the harvester based at least in part on the data received from the sensors, such as by adjusting an aggressiveness setting of a harvesting implement of the harvester, adjusting one or more operational settings of a cleaning related sub-system(s) of the harvester, adjusting the ground speed of the harvester, and/or the like. In addition to automatically controlling the operation of the harvester (or as an alternative thereto), the computing system may be configured to execute any other suitable control action in response to the loss-related and/or quality-related data, such as by storing the data for subsequent use; transmitting the data to a separate computing device; geo-referencing the data; tagging or associating the data with a given bale/module; and/or the like.

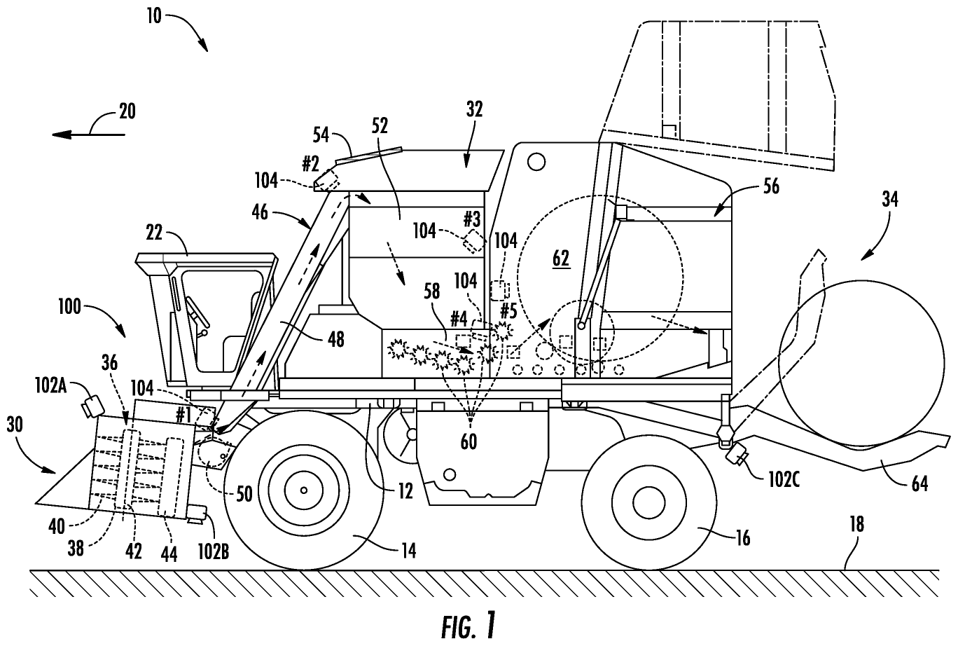

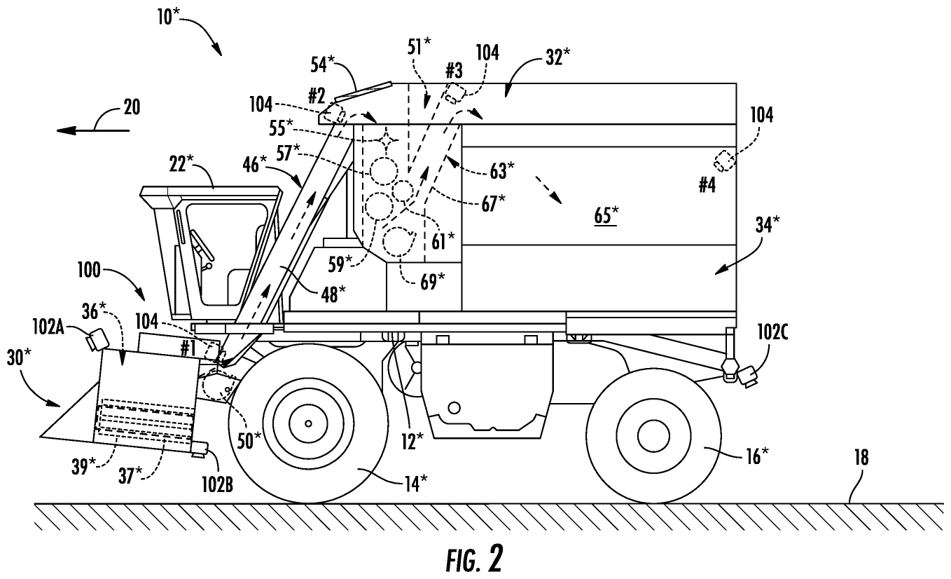

Referring now to the drawings, FIG. 1 illustrates a simplified, side view of one embodiment of a cotton harvester 10 in accordance with aspects of the present subject matter. In several embodiments, the cotton harvester 10 may be configured as a picker-type cotton harvester (hereinafter referred to as a cotton picker) that picks cotton from the plant while substantially leaving other materials attached to the plant or otherwise unharvested, such as a leaves, branches, stems, bark, and other trash or foreign matter (hereinafter referred to as “material other than cotton” or “MOC”). Alternatively, as will be described below with reference to FIG. 2, the cotton harvester may, instead, be configured as a stripper-type cotton harvester (hereinafter referred as a cotton stripper) that harvests cotton by removing the entire cotton boll along with other MOC, such as leaves, branches, stems, and the like, from the plant.

As shown in FIG. 1, the harvester 10 may include a main frame or chassis 12 supported by a pair of ground-engaging front wheels 14 and a pair of ground-engaging rear wheels 16. The wheels 14, 16 may be configured to support the harvester 10 relative to the surface of a field 18 and move the harvester 10 in a forward direction of movement (indicated by arrow 20 in FIG. 1) across the field 18 to allow the harvester 10 to harvest cotton. Additionally, an operator's platform with an operator's cab 22 may be supported by the chassis 12. As is generally understood, the harvester 10 may also include an engine and a transmission mounted on the chassis 12. The transmission may be operably coupled to the engine and may provide variably adjusted gear ratios for transferring engine power to one or both pairs of the wheels 14, 16 via a drive axle assembly (or via axles if multiple drive axles are employed).

Moreover, as shown in FIG. 1, a header or harvesting implement 30 is coupled and/or is supported relative to the chassis 12 at the front end of the harvester 10. In general, the harvesting implement 30 is configured to harvest materials from the field (e.g., including cotton and MOC) and deliver the harvested materials to a downstream material processing system 32 of the harvester 10. The material processing system 32 generally includes a plurality of components (many of which form assemblies or sub-systems of the harvester) through which the harvested materials are directed along a material transfer path (e.g., as indicated by the dashed arrows in FIG. 1) from the harvesting implement 30 to a final storage/exit location 34 (e.g., the exit point for the cotton bales in the illustrated embodiment).

In several embodiments, the harvesting implement 30 may be configured as a picker-type header or harvesting implement. In such an embodiment, as shown in FIG. 1, the harvesting implement 30 may include one or more picking units 36 (often generically referred to as row units). Each picking unit 36 includes one or more picker drums 38 and a plurality of spindles 40 rotatably coupled to each drum 38, with the spindles 40 being spaced apart from one another along the length and outer circumference of the respective drum 38. For example, sets of spindles 40 may be coupled or supported relative to each drum 40 via a spindle bar (not shown). The drum 38 of each picking unit 36 may be rotatable about a central drum axis 42, while each spindle 40 may be rotatable relative to its respective drum 38 about a spindle axis (e.g., extending generally perpendicular to the central drum axis 42). The rotation of each drum(s) 38 may, in one embodiment, be synchronized with the ground speed of the harvester 10. Additionally, each picking unit 36 may include one or more doffers 44 rotatably supported within the harvesting implement 30 at a location adjacent to the spindles 40 such that the spindles 40 pass by the doffer(s) 44 after picking cotton from the plant.

As the harvester 10 is moved through the field, the drums/spindles 38, 40 of each picking unit 36 are rotated relative to the cotton plants within the field, with the rotating spindles 40 being configured to pick or remove cotton from each plant. For instance, each spindle 40 may be tapered and/or have a barbed surface to allow the spindle 40 to grab the cotton and pick it from the plant as the cotton wraps around the rotating spindle 40. The spindles 40 then pass by the doffer(s) 44, which unwraps and strips the cotton from the spindles 40. After the cotton is removed from the spindles 40 by the doffer(s) 44, the spindles 40 may be passed by moistening pads or similar components to apply a liquid solution to each spindle 40.

The cotton removed from the spindles 40 via the doffers 44 is then transported vertically upwardly towards the top end of the machine via a pneumatic transport sub-system 46 of the material processing system 32. As shown in FIG. 1, the pneumatic transport sub-system 46 may include one or more transport ducts 48 and one or more associated fans 50 for generating an airflow through each respective duct 48. The upwardly-directed airflow through the duct(s) 48 carries the harvested materials from the picking unit(s) 36 of the harvesting implement 30 to an accumulation chamber 50 of the material processing system 32 within which the harvested materials are stored.

It should be appreciated that, in addition to conveying the harvested materials from the harvesting implement 30, the pneumatic transport sub-system 46 may also perform a cleaning function for the harvester 10 and, thus, may also be considered a cleaning-related sub-system of the material processing system 32. For instance, in one embodiment, heavier MOC (e.g., green bolls, rocks and other heavier trash) may be separated from the lighter harvested materials (e.g., cotton and lighter MOC) at the lower end and/or the upper end of the transport duct(s) 48 via gravitational settling. Additionally, in one embodiment, a screen 54 or similar structure may be provided at the upper end of the pneumatic transport sub-system 46 that is positioned above the outlet of the transport duct(s) 48 to allow any lighter MOC contained within the stream of harvested materials to be removed or separated from the cotton. For instance, lighter MOC may be directed through the screen 54 and out of the harvester 10 while heavier cotton pieces exit the pneumatic transport sub-system 46 and fall downwardly into the accumulation chamber 52.

In one embodiment, the harvested cotton may be maintained within the accumulation chamber 52 until the chamber 52 is full or the harvesting operation is completed, at which point the chamber 52 may be emptied. Alternatively, in instances in which the material processing system 32 includes a baling sub-system 56, the harvested cotton may be periodically transported from the accumulation chamber 52 for baling (e.g., when the harvested reaches a predetermined fill level within the accumulation chamber 52). For instance, as shown in FIG. 1, the material processing system 32 of the harvester 10 includes a feeder assembly 58 having a plurality of feeder rollers 60 configured to compress the harvested cotton and transfer it to a baling chamber 62 of the baling sub-system 56 for baling. Once the cotton bale is formed, it may be removed from the baling chamber 62 and discharged from the harvester 10 at the exit or termination point of the material transfer path of the material processing system 32 (e.g., via a rear bale handler 64).

Referring now to FIG. 2, a simplified, side view of another embodiment of a cotton harvester 10* is illustrated in accordance with aspects of the present subject matter. As shown, unlike the cotton harvester 10 described above with reference to FIG. 1, the cotton harvester 10* is configured as a stripper-type cotton harvester. Similar to the harvester embodiment described above, the harvester 10* includes a chassis 12* supported by a pair of ground-engaging front wheels 14* and a pair of ground-engaging rear wheels 16*, with the wheels 14, 16* being configured to support the harvester 10* relative to the surface of a field 18 and move the harvester 10* in a forward direction of movement (indicated by arrow 20 in FIG. 2) across the field to allow the harvester 10* to harvest cotton. Additionally, an operator's cab 22* and associated drive system components (e.g., an engine, transmission, drive axle(s), etc.) are also supported by the chassis 12*.

Moreover, as shown in FIG. 2, a header or harvesting implement 30* is coupled and/or is supported relative to the chassis 12* at the front end of the harvester 10*. In general, the harvesting implement 30* is configured to harvest materials from the field (e.g., including cotton and MOC) and deliver the harvested materials to a downstream material processing system 32* of the harvester 10*. The material processing system 32* generally includes a plurality of components (many of which form assemblies or sub-systems of the harvester 10*) through which the harvested materials are directed along a material transfer path (e.g., as indicated by the dashed arrows in FIG. 2) from the harvesting implement 30* to a final storage/exit location 34* (e.g., the final storage location for the harvested cotton in the illustrated embodiment).

Unlike the harvesting implement 30 described above with reference to FIG. 1, the harvesting implement 30* of FIG. 2 is as a stripper-type header or harvesting implement. In such an embodiment, as shown in FIG. 2, the harvesting implement 30* may include one or more stripper units 36* (often generically referred to as row units). Each stripper unit 36* includes one or more pairs rotating stripper drums 37* and a plurality of bats and/or brushes (shown generically as 39* in FIG. 2) extending outwardly from each drum 37*. For instance, in one embodiment, each stripper drum 37* may include a combination of stripper bats/brushes 39* spaced apart circumferentially from one another around the outer circumference of the drum 37*. As harvester 10* is moved through the field, the pairs of drums 37* of each stripper unit 36* are rotated in opposite directions with the cotton plants passing between the drums 37* such that the bats/brushes 39* strip away cotton, cotton bolls, and other MOC from the cotton plants. The harvested materials are conveyed from the drums 37* via one or more augers (not shown) of the harvesting implement 30*.

The materials harvested by the harvested implement 30) are then transported vertically upwardly towards the top end of the machine via a pneumatic transport sub-system 46* of the material processing system 32* of the harvester 10*. As shown in FIG. 2, the pneumatic transport sub-system 46* may include one or more transport ducts 48* and one or more associated fans 50* for generating an airflow through each respective duct 48*. The upwardly-directed airflow through the duct(s) 48* carries the harvested materials from the harvesting implement 30* to an onboard cleaning assembly 51* of the material processing system 32* (or, alternatively, to an accumulation chamber or storage device when no cleaning system is present). It should be appreciated that, in addition to conveying the harvested materials from the harvesting implement 30*, the pneumatic transport sub-system 46* may also perform a cleaning function for the harvester 10* and, thus, may also be considered a cleaning-related sub-system of the material processing system 32* (e.g., in addition to the onboard cleaning assembly 51*).

For instance, in one embodiment, heavier MOC (e.g., green bolls, rocks and other heavier trash) may be separated from the lighter harvested materials (e.g., cotton and lighter MOC) at the lower end and/or the upper end of the transport duct(s) 48* via gravitational settling. Additionally, in one embodiment, a screen 54* or similar structure may be provided at the upper end of the pneumatic transport sub-system 46* that is positioned above the outlet of the transport duct(s) 48* to allow any lighter MOC contained within the stream of harvested materials to be removed or separated from the cotton. For instance, lighter MOC may be directed through the screen 54* and out of the harvester 10* while heavier cotton pieces exit the pneumatic transport sub-system 46* and fall downwardly into the onboard cleaning assembly 51*.

In general, the onboard cleaning assembly 51* corresponds to a cleaning-related sub-system of the material processing system 32* that includes an assembly of rotating components adapted to separate harvested cotton from MOC. For instance, as shown schematically in FIG. 2, the cleaning assembly 51* may include a beater cylinder 55* that breaks up large wads or clumps of the harvested material prior to the materials being fed to one or more rotating saw drums (e.g., upper and lower saw drums 57*, 59*) that engage or grab the cotton such that it retained along the outer circumference of the drums 57*, 59* while MOC is thrown off the drums 57*, 59* via centrifugal forces and falls to the bottom of the cleaning assembly 51* for extraction via an associated cleaning auger (not shown). Additionally, the cleaning assembly 51* includes a doffer 61* positioned adjacent to the upper and lower saw drums 57*, 59*. The doffer 61* removes the cotton material from the saw drums 57*, 59* and places it in the airstream of a pneumatic transport sub-system 63* of the cleaning assembly 51* that carries the cotton upwardly for delivery to a storage device 65* of the material processing system 32* within which the harvested materials are stored. For instance, similar to the pneumatic transport sub-system 46* described above, the pneumatic transport sub-system 63* of the cleaning assembly 51* may include one or more transport ducts 67* and one or more associated fans 69* for generating an airflow through each respective duct 67*. The upwardly-directed airflow through the duct(s) 67* carries the cotton separated from the MOC by the cleaning assembly 51* to the storage device 65*.

As shown in FIG. 2, unlike the embodiment of the harvester 10 described above, the material processing system 32* of the illustrated harvester 10 does not include a baling sub-system. In such instance, the harvested materials may, for example, be maintained within the storage device 65* of the material processing system 32* (e.g., a basket or accumulation chamber) until the storage device 65* is full or the harvesting operation is completed, at which point the storage device 65* may be emptied. The storage device 65* may, in such an embodiment, define the downstream end of termination point of the material transfer path of the material processing system 32*. Alternatively, in instances in which the material processing system 32* includes a baling sub-system, the harvested materials may be periodically transported from the storage device 65* for baling within the baling sub-system (e.g., when the cotton reaches a predetermined fill level within the storage device 65*).

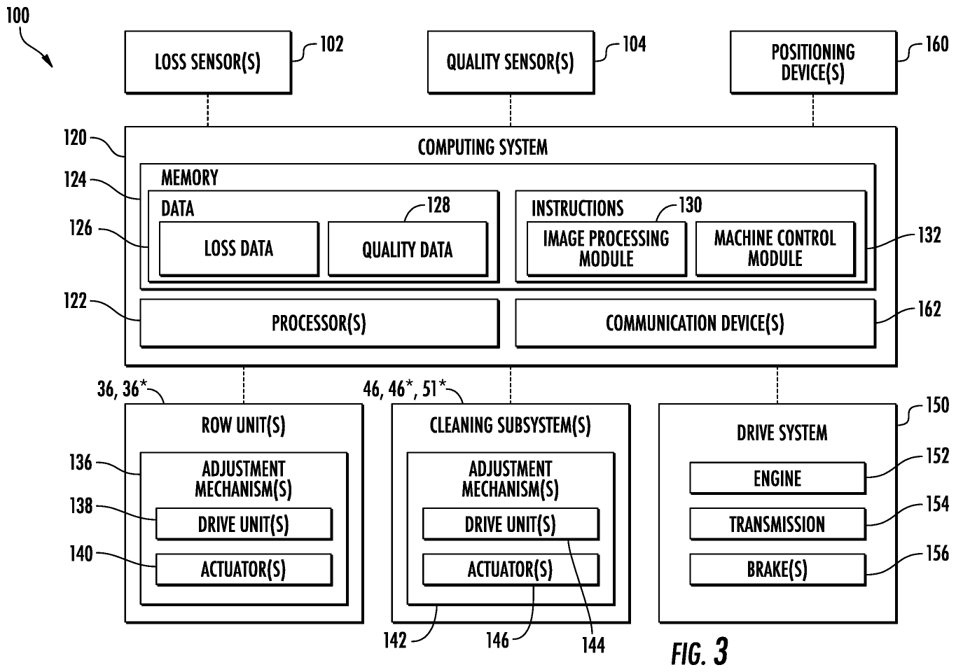

Referring now to both FIGS. 1 and 2, in accordance with aspects of the present subject matter, each harvester 10, 10* may include or be associated with a system 100 for automatically controlling the operation of one or more components of the harvester 10, 10*. In several embodiments, the system 100 may include one or more sensors for generating data associated with one or more harvest-related metrics or parameters (e.g., metrics associated with picking losses, the quality of the harvested materials, and/or the like). For instance, as shown in FIGS. 1 and 2, the system 100 may include one or more loss sensors 102 configured to generate data associated with harvest losses, such as the amount of cotton remaining within the field post-harvest (e.g., cotton on the ground and/or cotton still remaining on the cotton plants) and/or the amount of cotton existing on the cotton plants pre-harvest. Additionally, as shown in FIGS. 1 and 2, the system 100 may also include one or more quality sensors 104 configured to generate data associated with the quality of the harvested materials, such as by generating data associated with the amount of MOC contained within the harvested materials, the color of the harvested cotton, the presence of insect/fungal damage, the fiber thickness or micronaire of the cotton, and/or the like. As will be described below with reference to FIG. 3, the various sensors 102, 104 may be communicatively coupled to a computing system that is configured to automatically control the operation of the harvester 10, 10* based at least in part on the data received from the sensors 102, 104. For instance, the computing system may be configured to adjust an aggressiveness setting of the harvesting implement 30, 39*, adjust one or more operational settings of the cleaning related sub-system(s) of the harvester 10, 10*, and/or adjust the ground speed of the harvester 10, 10* to reduce harvest losses and/or increase/improve the quality of the harvested materials.

In several embodiments, each loss sensor(s) 102 may correspond to one or more imaging devices configured to capture images of the field to allow the images to be subsequently analyzed (e.g., using suitable imaging processing algorithms or computer-vision techniques) to estimate the amount of cotton remaining within the field post-harvest and/or the amount of cotton existing on the cotton plants pre-harvest. For instance, each loss sensor(s) 102 may correspond to one or more cameras, such as one or more stereo camera assemblies, one or more non-stereo cameras, one or more spectroscope cameras, one or more multi-spectrum cameras, and/or the like.

As shown in FIGS. 1 and 2, in several embodiments, the system 100 may include both a pre-harvest loss sensor 102A and a post-harvest loss sensor 102B, with the pre-harvest loss sensor 102A being configured to capture images of the field pre-harvest (e.g., at a location forward of the harvesting implement 30, 30* relative to the forward direction of travel 20 of the harvester 10, 10*) and the post-harvest loss sensor 102B being configured to capture images of the field post-harvest (e.g., at a location aft of the harvesting implement 30, 30* relative to the forward direction of travel 20 of the harvester 10, 10*). In such an embodiment, data may be captured that relates to both the amount of cotton existing within the field prior to harvesting and the amount of cotton remaining within the field after harvesting, which can then be used to calculate a loss ratio/percentage or harvesting efficiency for the harvester 10, 10*. For instance, by comparing the pre-harvest cotton amount to the post-harvest cotton amount, a loss percentage may be calculated that provides an indication of the performance of the harvesting implement 30, 30*, which can then be used to adjust the operation of the implement 30, 30* (e.g., by adjusting an aggressiveness setting of the implement 30, 30*). As shown in the illustrated embodiments, the pre-harvest and post-harvest loss sensors 102A, 102B are coupled to or otherwise installed on the harvesting implement 30, 30*. However, in other embodiments, the loss sensors 102 may be installed at any other suitable location that allows each loss sensor 102 to function as described herein, such as by mounting a pre-harvest loss sensor 102 at the top of the cab 22, 22* such that the sensor 102 had a field of view directed towards the field at a location forward to the harvesting implement 30, 30* and/or by mounting a post-harvest loss sensor 102 at the rear end of the harvester 10, 10* such that the sensor 102 had a field of view directed towards the field at a location aft of the machine. For instance, as shown in FIGS. 1 and 2, a post-harvest loss sensor 102C may be provided at the rear end of the harvester 10, 10*, which may allow for images of the cotton remaining within the field to be captured behind the machine. In one embodiment, the more forwardly-mounted post-harvest loss sensor 102B may be used to capture images used to determine the amount of cotton on the ground, while the more aft-mounted post-harvest loss sensor 102C may be used to capture images used to determine the amount of cotton remaining on the cotton plants. However, in other embodiments, the images from either post-harvest loss sensor 102B, 102C may be used to determine both the amount of cotton on the ground and the amount of cotton remaining on the cotton plants.

Additionally, in alternative embodiments, the system 100 may only include a pre-harvest loss sensor 102A or a post-harvest loss sensor 102B, 102C. For instance, by simply including a post-harvest loss sensor 102B, 102C, the images captured post-harvesting may be analyzed to determine the amount of cotton remaining within the field (e.g., on the ground and/or on the cotton plants), which can then be used to adjust the operation of the harvesting implement 30, 30*. Similarly, in an embodiment in which the system 100 only includes a pre-harvest loss sensor 102A, the pre-harvest cotton data generated by the sensor 102A may be utilized in combination with other data (e.g., yield data from a separate sensor) to estimate one or more loss-related metrics or parameters of the harvester 10, 10*.

It should be appreciated that the images captured by the loss sensor(s) 102 may be analyzed using any suitable image processing algorithm and/or computer vision technique to determine or estimate the amount of pre-harvest and/or post-harvest cotton within the field. For instance, in one embodiment, the images captured by the loss sensor(s) 102 may be analyzed to identify the amount or percentage of white or near-white pixels within each image, which may then be used to estimate the total amount of pre-harvest and/or post-harvest cotton within the field.

Referring still to FIGS. 1 and 2, as indicated above, the system 100 may also include one or more quality sensors 104 configured to generate data associated with the quality of the harvested materials. For instance, data related to one or more quality-related metrics, such as the amount of MOC contained within the harvested materials (or the ratio between cotton and MOC within the harvested materials), the color of the harvested cotton, the presence of insect/fungal damage, the fiber thickness or micronaire of the cotton, and/or the like, may be detected and analyzed to estimate the overall quality of the harvested materials. In general, the quality sensor(s) 104 may be located at any suitable position on or within the harvester10, 10* that allows the sensor(s) 104 to capture quality-related data associated with the harvested materials being directed along the material transfer path of the material processing system 32, 32* at a point downstream of the harvesting implement 30, 30*.

For instance, as shown in FIG. 1, a quality sensor 104 may be installed: (1) in association with one or more components of the pneumatic transport sub-system 46 such that the sensor 104 captures data associated with the harvested materials being directed through such sub-system 46 (e.g., by placing a quality sensor(s) 104 at or adjacent to the inlet of the pneumatic transport sub-system 46, such as at the bottom end of the transport duct(s) 48 as shown at example position #1 in FIG. 1, and/or at or adjacent to the outlet of the pneumatic transport sub-system 46, such as at the top end of the transport duct(s) 48 as shown at example position #2 in FIG. 1); (2) in association with the accumulation chamber 52 such that the sensor 104 captures data associated with the harvested materials within the chamber 52 (e.g., as shown at example position #3 in FIG. 1); (3) in association with the feeder assembly 58 such that the sensor 104 captures data associated with the harvested materials transported through the assembly 58 (e.g., as shown at example position #4 in FIG. 1); (4) in association with the baler sub-system 56 such that the sensor 104 captures data associated with the harvested materials positioned within the baling chamber 62 (e.g., as shown at example position #5 in FIG. 1); (5) or at any other suitable location between the upstream and downstream ends of the material transfer path extending from the harvesting implement 30.

Similarly, as shown in FIG. 2, a quality sensor 104 may be installed: (1) in association with one or more components of the pneumatic transport sub-system 46* such that the sensor 104 captures data associated with the harvested materials being directed through such sub-system 46* (e.g., by placing a quality sensor(s) 104 at or adjacent to the inlet of the pneumatic transport sub-system 46*, such as at the bottom end of the transport duct(s) 48* as shown at example position #1 in FIG. 2, and/or at or adjacent to the outlet of the pneumatic transport sub-system 46*, such as at the top end of the transport duct(s) 48* as shown at example position #2 in FIG. 2); (2) in association with the cleaning assembly 51* such that the sensor 104 captures data associated with the harvested materials being processed by such assembly 51* (e.g., by placing a quality sensor(s) 104 at or adjacent to the inlet of the pneumatic transport system 63* of the cleaning assembly 51*, such as at the bottom end of the transport duct(s) 67*, and/or at or adjacent to the outlet of the pneumatic transport system 63* of the cleaning assembly 51*, such as at the top end of the transport duct(s) 67* as shown at example position #3 in FIG. 2); (3) in association with the storage device 65* such that the sensor 104 captures data associated with the harvested materials contained within the storage device 65* (e.g., as shown at example location #4 in FIG. 2); (4) or at any other suitable location between the upstream and downstream ends of the material transfer path extending from the harvesting implement 30*.

It should be appreciated that, although FIGS. 1 and 2 illustrate numerous quality sensors 104 positioned at various locations along the material transfer paths of the respective material processing systems 32 to provide examples of different potential sensor locations, the system 100 may, in certain embodiments, only include a single quality sensor 104 positioned along the material transfer path at a location downstream of the harvesting implement 30, 30*. For instance, in one embodiment, a single quality sensor 104 may be positioned at a location at least partially downstream of one or more of the cleaning-related sub-systems of the harvester 10, 10*, such as at one of example locations #2, #3, #4, and #5 in FIG. 1 or at one of example locations #2, #3, and #4 in FIG. 2, to provide post-cleaning data associated with the quality of the harvested materials. In another embodiment, a single quality sensor 104 may be positioned at a location at least partially upstream of one or more of the cleaning-related sub-systems of the harvester 10, 10*, such as at example location #1 in FIG. 1 or at one of example locations #1 or #2 in FIG. 2, to provide pre-cleaning data associated with the quality of the harvested materials. Additionally, in further embodiments, a combination of quality sensors 104 may be used to provide both pre-cleaning and post-cleaning data associated with the quality of the harvested materials. For instance, in one embodiment, a first quality sensor 104 may be provided at the inlet of the pneumatic transport system 46, 46* (e.g., at example location #1 in FIGS. 1 and 2) to provide pre-cleaning data and a second quality sensor 104 may be provided downstream of at least a portion of one or more of the cleaning-related sub-systems of the harvester 10, such as at one or more of example locations #2, #3, #4, or #5 in FIG. 1 or at one or more of example locations #2, #3, or #4 in FIG. 2, to provide post-cleaning data, thereby allowing the pre-cleaning and post-cleaning data to be compared/contrasted to determine the effectiveness of the cleaning-related sub-system(s) of the harvester 10, 10*. For instance, quality sensors 104 at the upstream and downstream ends of the pneumatic transport system 46, 46* may be used to detect the amount of MOC contained within the harvested materials at each location, thereby allowing the effectiveness of the cleaning functionality provided by the pneumatic transport system 46, 46* to be determined. Similarly, quality sensors 104 positioned upstream and downstream of the onboard cleaning assembly 51* may be used to detect the amount of MOC contained within the harvested materials at each location, thereby allowing the effectiveness of such assembly 51* to be determined.

It should be appreciated that, in some embodiments, the positioning of the quality sensor(s) 104 along the material transfer path may vary depending on which quality-related metric is being monitored via the data provided by the sensor(s) 104. For instance, as indicated above, when monitoring the cleanliness of the harvested materials (e.g., the amount of MOC contained within the harvested materials), the quality sensor(s) 104 may be positioned upstream and/or downstream of the cleaning-related sub-system(s) of the harvester 10, 10*. However, when monitoring a different quality-related metric (e.g., the color of the harvested cotton, the presence of insect/fungal damage, the fiber thickness or micronaire of the cotton, etc.), it may be desirable to position the quality sensor(s) 104 downstream of the cleaning-related sub-system(s) of the harvester 10, 10* such that the sensor(s) 104 can detect the post-cleaning state of the harvested cotton. For instance, for such quality-related metrics, it may be desirable to install the quality sensor(s) at example locations #3, #4, and/or #5 in FIG. 1 or at example locations #3 and/or #4 in FIG. 2.

It should also be appreciated that, in several embodiments, each quality sensor(s) 104 may correspond to one or more imaging devices configured to capture images of the harvested materials at one or more locations along the material transfer path defined through the material processing system 32, 32* to allow the images to be subsequently analyzed (e.g., using suitable imaging processing algorithms or computer-vision techniques) to generate data associated with the quality of the harvested materials. For instance, each quality sensor(s) 104 may correspond to one or more cameras, such as one or more stereo camera assemblies, one or more non-stereo cameras, one or more spectroscope cameras, one or more multi-spectrum cameras and/or the like.

Additionally, in one embodiment, each quality sensor(s) 104 may include or be associated with one or more light sources to assist in detecting the quality of the harvested materials. For instance, a blue light source and/or an ultraviolet (UV) light source may be provided to allow blue excitation light and/or UV-excited fluorescence to be used to detect MOC within the flow of harvested materials. Specifically, blue excitation light may allow for certain types of MOC (e.g., bark, brown and green leaves, hulls, etc.) to be detected more efficiently while UV-excited fluorescence may allow for other types of MOC (e.g., seeds, seed coatings, and non-plant material) to be detected more efficiently. UV-excited fluorescence may also be used to detect certain types of damage, such as insect or fungal damage. In addition, a near-infrared (NIR) light source may also be used to provide NIR excitation light, which may facilitate the detection of certain quality-related metrics, such as fiber thickness or micronaire of the cotton.

It should be appreciated that the images captured by the quality sensor(s) 104 may be analyzed using any suitable image processing algorithm and/or computer vision technique to determine or estimate the quality of the harvested materials. For instance, in one embodiment, the images captured by the quality sensor(s) 104 may be analyzed to identify MOC within the harvested materials and/or to differentiate cotton from MOC within the harvested materials, which may then be used to estimate the total amount of MOC within the harvested materials or the relative amount of MOC compared to the amount of cotton within the harvested materials. The image processing algorithm and/or computer vision technique may rely upon, for example, hyperspectral fluorescence data from the images to detect MOC or otherwise differentiate MOC from cotton. Similarly, in one embodiment, the image processing algorithm and/or computer vision technique may rely upon, for example, fluorescence data to identify insect/fungal damage and/or NIR data to detect the fiber thickness (e.g., micronaire) of the harvested cotton.

Referring now to FIG. 3, a schematic view of various components that may be included within one or more embodiments of a system 100 for automatically controlling the operation of a cotton harvester is illustrated in accordance with aspects of the present subject matter. In general, the system 100 will be described with reference to the cotton harvesters 10, 10* and various system components described above with reference to FIGS. 1 and 2. However, in other embodiments, the disclosed system 100 may be implemented with cotton harvesters having any other suitable harvesting configuration and/or with any other suitable combination of system components.

As shown in FIG. 3, the system 100 includes one or more sensors 102, 104 for generating data associated with one or more harvest-related parameters of a cotton harvester. For instance, as described above, the system 100 may include one or more loss sensors 102 configured to generate data associated with harvest losses (e.g., the amount of cotton remaining within the field post-harvest and/or the amount of cotton existing on the cotton plants pre-harvest) and one or more quality sensors 104 configured to generate data associated with the quality of the harvested materials (e.g., the amount of MOC contained within the harvested materials, the color of the harvested cotton, the presence of insect/fungal damage, the fiber thickness or micronaire of the cotton, and/or the like). As described above, each of the various sensors 102, 104 may, in several embodiments, correspond to one or more imaging device (e.g., one or more cameras) and may optionally include or be associated with one or more light sources for providing artificial light (e.g., an excitation light) when capturing images via the imaging devices.

Additionally, as shown in FIG. 3, the system 100 may also include a computing system 120 communicatively coupled to the various sensors 102, 104 to allow sensor data generated by the sensors 102, 104 (e.g., images or other image data) to be transmitted to the computing system 120 for subsequent processing and/or analysis. For instance, the computing system 120 may be configured to analyze the sensor data to determine one or more loss-related metrics and/or one or more quality-related metrics associated with the harvested materials. Additionally, as will be described below, the computing system 120 may also be configured to automatically control or adjust the operation of the harvester 10, 10* based on the determined metric(s). For instance, based on the loss-related and/or quality-related data, the computing system 120 may be configured to adjust an aggressiveness setting of the associated harvesting mechanism 30, 30*, adjust an operational setting of one or more of the cleaning-related sub-systems (e.g., the pneumatic transport sub-system(s) 46, 46* and/or the cleaning assembly 51*), and/or adjust the ground speed of the harvester 10, 10*.

In general, the computing system 120 may correspond to any suitable processor-based device(s), such as a computing device or any combination of computing devices. Thus, in several embodiments, the computing system 120 may include one or more processor(s) 122 and associated memory device(s) 124 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 124 of the computing system 120 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 124 may generally be configured to store suitable computer-readable instructions that, when implemented by the processor(s) 122, configure the computing system 120 to perform various computer-implemented functions, such as one or more aspects of the methods described herein.

In one embodiment, the memory 124 of the computing system 120 may include one or more databases for storing information associated with the operation of the harvester 10, 10*, including data associated with one or more harvest-related parameters of the harvester 10, 10*. For instance, as shown in FIG. 3, the memory 124 may include a loss database 126 storing data associated with harvesting losses, such as pre-harvest and post-harvest cotton amounts as determined based on the data received from the loss sensor(s) 102 and/or various other related metrics/parameters (e.g., a calculated loss percentage/ratio or harvesting efficiency). Additionally, as shown in FIG. 3, the memory 124 may include a quality database 128 storing data associated with the quality of the harvested materials, such as the amount of MOC contained within the harvested materials at one or more locations along the material transfer path of the harvester 10, 10*, the color of the harvested cotton, the presence of insect/fungal damage, the fiber thickness or micronaire of the cotton, and/or the like.

Referring still to FIG. 3, in several embodiments, the memory 124 of the computing system 120 may store instructions that, when executed by the processor(s) 122, configure the computing system 120 to execute an image processing module 130 for processing/analyzing the images and/or other data received from the various sensors 102, 104. Specifically, the image processing module 130 may be configured to execute suitable image processing algorithms and/or computer vision techniques for generating data associated with one or more relevant metrics/parameters associated with the operation of the harvester 10, 10* (e.g., one or more loss-related and/or quality-related metrics). For instance, the images captured by the loss sensor(s) 102 may be analyzed to identify the amount of pre-harvest and/or post-harvest cotton within the field. Similarly, the images captured by the quality sensor(s) 104 may be analyzed to identify the amount of MOC contained within the harvested materials (including the amount of MOC relative to the amount of cotton within the harvested materials) at one or more locations along the material transfer path defined through the harvester 10, 10*. The images captured by the quality sensor(s) 104 may also be analyzed to determine one or more other quality-related metrics, such as the color of the cotton, the presence of insect/fungal damage, the fiber thickness or micronaire of the cotton, etc.

Moreover, as shown in FIG. 3, the memory 124 of the computing system 120 may also store instructions that, when executed by the processor(s) 122, configure the computing system 120 to execute a machine control module 132 for automatically controlling the operation of one or more components of the harvester 10, 10* in response to the harvesting-related metrics determined based on the data received from the sensors 102, 104. As will be described below, the computing system 120 may be configured to execute various different control actions based on the determined metrics, including controlling the operation of one or more components of each row unit of the harvester 10, 10* (e.g., the picking unit(s) 36 and/or the stripper unit(s) 36*), one or more components of one or more of the cleaning-related sub-systems of the harvester (e.g., the pneumatic transport sub-system(s) 46, 46* and/or the cleaning assembly 51*), and/or one or more components of a drive system 150 of the harvester 10, 10* to improve the overall efficiency and/or the effectiveness of the harvester operation.

As shown in FIG. 3, the computing system 120 may be communicatively coupled to one or more adjustment mechanisms 136 of each row unit of the harvester 10, 10* (e.g., each picker unit 36 or stripper unit 36*) to allow the operational settings of the row unit to be adjusted. For instance, in the illustrated embodiment, the computing system 120 may be communicatively coupled to one or more drive units 138 (e.g., rotational drive units, such as a motors) and/or one or more actuators 140 (e.g., linear actuators, rotational actuators, and/or the like) to adjust the operational settings of the row unit. Specifically, in several embodiments, the operation of the adjustment mechanisms 136 may be controlled by the computing system 120 to adjust one or more aggressiveness settings of each row unit. The aggressiveness settings may correspond, for example, to the rotational speed of one or more components of the row unit, the spacing or relative positioning between components of the row unit, and/or any other operational settings that impact how aggressively the row unit picks or strips cotton and MOC from the cotton plants within the field. For instance, with reference to the picker-type harvesting implement 30 described above with reference to FIG. #, the computing system 120 may be configured to: (1) adjust the rotational speed of the picker drums 38, spindles 40, and/or doffers 44 of each picker unit 36 (e.g., via control of an associated or respective drive unit(s) 138); (2) adjust the spacing or relative positioning between adjacent drums 38 or between a given drum 38 and associated pressure/scrapping plate (e.g., via associated or respective actuator(s) 140); (3) adjust the spacing or relative positioning between the spindles 40 and the doffer(s) 44 (e.g., via an associated or respective actuator(s) 140); and/or (4) adjust any other suitable operating settings that impact the aggressiveness of the picker unit 36. Similarly, with reference to the stripper-type harvesting implement 30* described above with reference to FIG. 2, the computing system 120 may be configured to: (1) adjust the rotational speed of the stripper drums 37* of each stripper unit 36* (e.g., via control of an associated or respective drive unit(s) 138); (2) adjust the spacing or relative positioning between adjacent stripper drums 37* or between a given drum 37* and associated pressure/scrapping plate (e.g., via associated or respective actuator(s) 140); and/or (3) adjust any other suitable operating settings that impact the aggressiveness of the stripper unit 36*.

Additionally, as shown in FIG. 3, the computing system 120 may be communicatively coupled to one or more adjustment mechanisms 142 of the cleaning sub-system(s) of the harvester 10, 10* (e.g., the pneumatic transport sub-system 46, 46*, 51* and/or cleaning assembly 51) to allow the operational settings of such sub-system(s) to be adjusted. For instance, in the illustrated embodiment, the computing system 120 may be communicatively coupled to one or more drive units 144 (e.g., rotational drive units, such as a motors) and/or one or more actuators 146 (e.g., linear actuators, rotational actuators, and/or the like) to adjust the operational settings of the cleaning-related sub-system(s). Specifically, with reference to the picker-type harvester 10 described above with reference to FIG. 1, the computing system 120 may be configured to: (1) adjust the fan speed of the fan(s) 50 of the pneumatic transport sub-system 46 (e.g., via control of an associated or respective drive unit(s) 144); (2) adjust the spacing or opening defined at the inlet of the pneumatic transport system 46 (e.g., via an associated or respective actuator(s) 146); and/or (4) adjust any other suitable operating settings that impact the effectiveness of the cleaning sub-system(s) of the harvester 10. Similarly, with reference to the stripper-type harvester 10* described above with reference to FIG. 2, the computing system 120 may be configured to: (1) adjust the fan speed of the fan(s) 50*, 69* of the primary pneumatic transport sub-system 46* or the pneumatic transport sub-system 63* of the cleaning assembly 51* (e.g., via control of an associated or respective drive unit(s) 144); (2) adjust the spacing or opening defined at the inlet of the pneumatic transport sub-system 46*, 63* (e.g., via an associated or respective actuator(s) 146); (3) adjust the rotational speed of one or more components of the cleaning assembly 51*, such as the beater 55*, the saw drums 57*, 59*, and/or the doffer 61* ((e.g., via control of an associated or respective drive unit(s) 144); (4) adjust the spacing or relative positioning between one or more adjacent components of the cleaning assembly 51* (e.g., via an associated or respective actuator(s) 146); and/or (5) adjust any other suitable operating settings that impact the effectiveness of the cleaning sub-system(s) of the harvester 10.

Moreover, as shown in FIG. 3, the computing system 120 may be communicatively coupled to one or more components of the drive system 150 to allow the ground speed of the harvester 10, 10* to be adjusted. For instance, in several embodiments, the drive system 150 may include an engine 152, a transmission operably coupled to the engine 154, and one or more associated braking devices 156. In such embodiments, the computing system 120 may be configured to control the operation of the drive system components (e.g., individually or in combination) to adjust the ground speed of the harvester 10, 10*.

It should be appreciated that, although the computing system 120 is generally described herein as being configured to adjust the operation of one or more components of the harvesting implement 30, 30*, cleaning-related sub-system(s), and/or the drive system 150 of the harvester 10, 10* based on one or more harvesting-related metrics, the computing system 120 may be configured to automatically control and adjust the operation of any suitable system, sub-system, assembly or component in response to any suitable metric. For instance, in one embodiment, one or more components of the feeder assembly 58 and/or the baling sub-system 56 may be automatically controlled based on the harvesting-related metric(s) determined in response to the data received from the loss sensor(s) 102 and/or the quality sensor(s) 104.

### Machine Control Based on Loss Metrics/Parameters

As indicated above, the computing system 120 may be configured to receive data (e.g., image data) from the loss sensor(s) 102 and analyze the sensor data to determine one or more harvesting loss-related metrics, such as the amount of cotton remaining within the field post-harvesting or a loss percentage/ratio or harvesting efficiency (e.g., as determined as a function of the estimated pre-harvest and post-harvest amounts of cotton within the field). In such embodiments, the computing system 120 may be configured to compare the loss-related metric(s) to an associated threshold to determine whether the harvesting implement is effectively harvesting cotton from the field (e.g., whether harvesting losses are too high or within an acceptable range). For instance, a “remaining cotton” threshold may be stored within the memory 124 of the computing system 120 that defines a maximum threshold value for the amount of cotton remaining within the field above which it can be inferred that the harvesting implement 30, 30* is not effectively harvesting cotton from the field. Similarly, associated thresholds may be defined for a calculated loss percentage/ratio (e.g., a maximum loss percentage/ratio threshold) and/or a calculated harvesting efficiency (e.g., a minimum harvesting efficiency threshold) to assess the performance of the harvesting implement 30, 30*.

In the event that the computing system 120 determines that the harvesting implement 30, 30* is not effectively harvesting cotton from the field based on the data received from the loss sensor(s) 102 (e.g., harvesting losses are too high), the computing system 120 may be configured to automatically adjust the operation of the associated row unit(s) 36, 36*, such as by controlling the operation of the relevant adjustment mechanism(s) 136, to improve the effectiveness of the harvesting implement 30, 30*. For instance, when harvesting losses are too high, the computing system 120 may be configured to increase the aggressiveness of the harvesting implement 30, 30* to increase the likelihood of cotton being picked or stripped from the cotton plants within the field. In addition to increasing the aggressiveness of the harvesting implement 30, 30* (or as an alternative thereto), the computing system 120 may be configured to automatically control the operation of the drive system 150 to reduce the ground speed of the harvester 10, 10*. Moreover, in instances in which the aggressiveness of the harvesting implement 30, 30* is being increased, the computing system 120 may also be configured to adjust one or more operational settings of the cleaning-related sub-system(s) of the harvester 10 to account for the additional amount of MOC that may be contained within the harvested materials due to the increased aggressiveness.

In contrast, if the computing system 120 determines that the harvesting implement 30, 30* is effectively harvesting cotton from the field based on the data received from the loss sensor(s) 102 (e.g., harvesting losses are low or otherwise within an acceptable range), the computing system 120 may, in certain embodiments, be configured to adjust one or more machine settings to improve the cleanliness of the harvested materials and/or increase the efficiency of the harvester 10, 10*. For instance, when harvesting losses are very low or minimal (particularly when such low losses are coupled with a high amount of MOC contained within the flow of harvested materials as determined via the quality sensor(s) 104) it may be desirable decrease the aggressiveness of the harvesting implement 30, 30* to reduce the amount of MOC being captured by the implement 30, 30* (e.g., in instances in which a significant amount of MOC is still having to be removed by the cleaning-related sub-system(s)). Additionally, when harvesting losses are low, the computing system 120 may be configured to automatically control the operation of the drive system 150 to increase the ground speed of the harvester 10, 10* to determine if the harvester 10, 10* can be moved through the field at a higher speed without substantially impacting losses.

### Machine Control Based on Cleanliness of the Harvested Materials

As indicated above, the computing system 120 may be configured to receive data (e.g., image data) from the quality sensor(s) 104 and analyze the sensor data to determine the amount of MOC contained within the harvested materials. For instance, in one embodiment, the computing system 120 may be configured to determine the amount of MOC contained within the harvested materials at a location upstream and/or downstream of one or more of the cleaning-related sub-systems of the harvester 10, 10*. The pre-cleaned or post-cleaned cleanliness data may then be used to automatically control the operation of one or more components of the harvester 10, 10*.

For example, in embodiments in which the quality sensor(s) 104 is installed at a location downstream of at least a portion of the cleaning-related sub-system(s) such that the computing system 120 determines a post-cleaned amount of MOC contained within the harvested materials (e.g., at example locations #2, #3, #4, and #5 in FIG. 1 and at example locations #2, #3, and #4 in FIG. 2), the computing system 120 may be configured to compare the post-cleaned MOC amount to an associated post-cleaned MOC threshold to determine whether too much MOC is still present in the flow of harvested materials downstream of the cleaning-related sub-system(s). In the event that the post-cleaned MOC amount exceeds the associated threshold, the computing system 120 may be configured to: (1) adjust one or more operational settings of the cleaning-related sub-system(s) in a manner that increases the likelihood of MOC being removed from the harvested materials; (2) reduce the aggressiveness of the harvesting implement 30, 30* to decrease the likelihood of MOC being picked or stripped from the cotton plants within the field; and/or (3) a combination of both control actions. In addition to adjusting the cleaning system settings and/or reducing the aggressiveness of the harvesting implement 30, 30* (or as an alternative thereto), the computing system 120 may be configured to automatically control the operation of the drive system 150 to adjust the ground speed of the harvester 10, 10* in a manner that provides for a reduction in the intake of MOC.

Similarly, in embodiments in which the quality sensor(s) 104 is installed at a location upstream of the cleaning-related sub-system(s) such that the computing system 120 determines a pre-cleaned amount of MOC contained within the harvested materials (e.g., at example location #1 in FIGS. 1 and 2 adjacent to the inlet of the pneumatic transport system 46, 46*), the computing system 120 may be configured to compare the pre-cleaned MOC amount to an associated pre-cleaned MOC threshold to determine whether the harvesting implement 30, 30* is intaking too much MOC. In the event that the pre-cleaned MOC amount exceeds the associated threshold, the computing system 120 may be configured to reduce the aggressiveness of the harvesting implement 30, 30* to decrease the likelihood of MOC being picked or stripped from the cotton plants within the field. In addition to reducing the aggressiveness of the harvesting implement 30, 30* (or as an alternative thereto), the computing system 120 may be configured to automatically control the operation of the drive system 150 to adjust the ground speed of the harvester 10, 10* in a manner that provides for a reduction in the intake of MOC.

Additionally, in embodiments in which quality sensors 104 are installed at locations both downstream and upstream of the cleaning-related sub-system(s) such that the computing system 120 determines both a pre-cleaned amount and a post-cleaned amount of MOC contained within the harvested materials, the computing system 120 may be configured to compare such MOC amounts to determine the overall effectiveness of the cleaning sub-system(s) in removing MOC from the harvested materials. For instance, the computing system 120 may be configured to compare the ratio of pre-cleaned and post-cleaned MOC amounts or an associated percent reduction of MOC to an associated threshold(s) to evaluate the effectiveness of the cleaning sub-system(s). In the event that the computing system 120 determines that the cleaning sub-system(s) is not effectively removing MOC from the harvested materials, the computing system 120 may, for example, initially prioritize making adjustments to the cleaning system settings over making adjustments to the aggressiveness of the harvesting implement 30, 30* to determine if the performance of the cleaning sub-system(s) can be improved. Alternatively, in the event that the computing system 120 determines that the cleaning sub-system(s) appears to be effectively removing MOC from the harvested materials (but MOC still remains in the post-cleaned harvested materials), the computing system 120 may, for example, initially prioritize making adjustments to the aggressiveness of the harvesting implement 30, 30* as opposed to making adjustments to the cleaning system settings in an attempt to reduce the overall amount of MOC being picked off or stripped from the cotton plants.

### Machine Control Based on Loss and Quality Metrics

In several embodiments, the computing system 120 may be configured to automatically control the operation of the harvester 10, 10* based on a combination of the loss/quality metrics determined using the sensor data received from the loss sensor(s) 102 and the quality sensor(s) 104. For instance, the computing system may be configured to automatically control the operation of the harvester 10, 10*, such as by adjusting the aggressiveness of the harvesting implement 30, 30*, adjusting an operational setting of one or more of the cleaning-related sub-systems, and/or adjusting the ground the speed of the harvester 10, 10*, based on both the amount of cotton remaining within the field (e.g., based on the data from the loss sensor(s) 102) and the amount of MOC contained within the harvested materials (e.g., based on the data from the quality sensor(s) 104).

In one embodiment, the operator may be allowed to set certain loss/quality thresholds and/or select a certain operating mode that is associated with maintaining losses/quality within an acceptable range. In such an embodiment, the computing system 120 may be configured to automatically control the operation of the harvester 10, 10* in order to maintain the performance of the machine within the operator-selected parameters or ranges (including any operator-selected priorities for one or more of the metrics being monitored).

In one embodiment, the operator may select between a low loss mode in which minimizing losses is prioritized over maximizing quality and a high quality mode in which maximizing quality is prioritized over minimizing losses. For example, in the low loss mode, the acceptable range for harvesting losses may be set quite low while the acceptable quality range associated with the amount of MOC contained within the harvested materials may allow for a higher quantity of MOC than would otherwise be acceptable when operating in the high quality mode. Similarly, in the high quality mode, the acceptable range associated with the amount of MOC contained within the harvested materials may be set quite low while the acceptable range for harvesting losses may allow for more losses than would otherwise be acceptable in the low loss mode. In such an embodiment, based on the operating mode selected by the operator, the computing system may be configured to automatically control the operation of the harvester 10, 10* using the sensor data received from the loss sensor(s) 102 and the quality sensor(s) 104 to maintain the associated loss/quality metrics within the desired/acceptable ranges. It should be appreciated that, in other embodiments, additional operating modes may be provided to the operator for selection, such as a high capacity mode in which a related capacity or intake metric is prioritized over any associated loss/quality metrics. Additionally, in some embodiments, the operator may be able to customize the operating modes based on his/her preference, such as by allowing the operator to apply different weights to the priority level to be given to certain metrics (e.g., losses/quality/capacity/etc.) or by allowing the operator to select an operating mode along a sliding scale between two or more operating modes (e.g., a sliding scale between the low loss mode at one end and the high quality mode at the other end).

### Control Actions Based on Other Quality Metrics

As indicated above, the computing system 120 may be configured to receive data (e.g., image data) from the quality sensor(s) 104 and analyze the sensor data to determine one or more quality-related metrics. In instances in which the quality-related metric being monitored is impacted by the performance of the harvester 10, 10* (e.g., the cleanliness of the harvested materials), the computing system 120 may be configured to automatically control the operation of the harvester 10, 10* to improve the overall quality of the harvested cotton, as desired. However, in some instances, the quality-related metric being monitored (e.g., the color of the harvested cotton, the presence of insect/fungal damage, the fiber thickness or micronaire of the cotton, and/or the like) will be independent of operation of the harvester 10, 10*. In such instances, the computing system 120 may be configured to: (1) log or store the quality data within its memory 124; (2) transmit the quality data to a separate computing device (e.g., a remote sever or a client device); (3) geo-reference the quality data to allow for quality mapping and/or subsequent bale/module correlation; (4) tag or associate the quality data with a given bale/module; (5) and/or perform any other suitable control actions.

For instance, as shown in FIG. 3, the computing system 120 may, in several embodiments, be communicatively coupled to a positioning device 160 configured to determine the exact location of the harvester 10, 10* using a satellite-based positioning system (e.g., a GPS system, a Galileo positioning system, the Global Navigation satellite system (GLONASS), the BeiDou Satellite Navigation and Positioning system, and/or the like). In such an embodiment, any quality data collected by the computing system 120 can be geo-referenced (e.g., by correlating the location coordinates provided by the positioning device 160 to the quality data based on time stamps or metadata associated with the position/quality data). The geo-referenced quality data may then be stored within memory 124 of the computing system 120 and/or transmitted to a separate computing device. For example, as shown in FIG. 3, the computing system 120 may include a communications device 162 (e.g., a transceiver) that facilitates the transfer of data to a separate computing device across a network via a wired via wired and/or wireless connection. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

Additionally, as indicated above, the computing system 120 may, in several embodiments, be configured to tag or otherwise associate quality data with a given bale/module. For instance, in one embodiment, the computing system 120 may be configured to cause the quality data to be written into an RFID tag or other similar tagging device that can be subsequently associated with a corresponding bale as it is being created within the harvester 10, 10*, such as by integrating or placing the tag on/into the cover or wrapping for the bale. In such instance, when the bale is subsequently collected within the field, a suitable electronic reader may be used to collect the quality data to provide an indication of the overall quality of the cotton included within the bale.

It should be appreciated that, in addition to tagging or otherwise associating non-harvester-related quality data with a given bale/module (or as an alternative thereto), the computing system 120 may also be configured tag or otherwise associate any other suitable data with a given bale/module. For instance, cleanliness data may also be tagged with each bale/module to provide an indication of the amount or percentage of MOC contained within the bale/module.

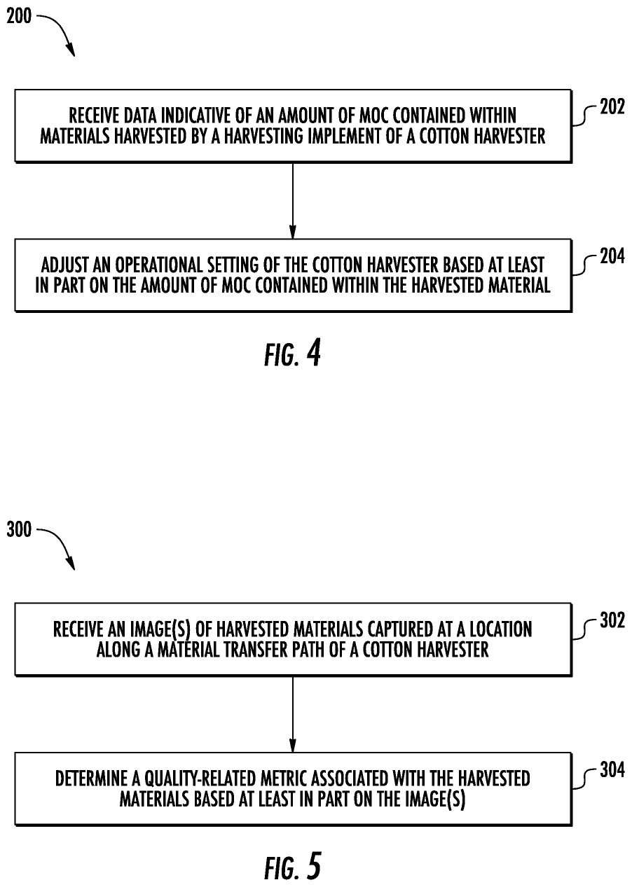

Referring now to FIG. 4, a flow diagram of one embodiment of a method 200 for automatically controlling the operation of a cotton harvester is illustrated in accordance with aspects of the present subject matter. For purposes of discussion, the method 200 will generally be described herein with reference to the harvester embodiments and system embodiments shown in FIGS. 1-3. However, it should be appreciated that the disclosed method 200 may be executed to control the operation of a cotton harvester having any other suitable harvesting configuration and/or in association with any suitable system having any other suitable system configuration. Additionally, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 includes receiving data indicative of an amount of MOC contained within materials harvested by a harvesting implement of a cotton harvester. For example, as indicated above, the computing system 120 may be configured to receive data from one or more quality sensors 104 associated with the amount of MOC contained within the harvested materials, such as post-cleaning and/or pre-cleaning data indicative of the amount of MOC contained within the harvested materials.

Additionally, as shown in FIG. 4, at (204), the method 200 includes adjusting an operational setting of the cotton harvester based at least in part on the amount of MOC contained within the harvested materials. For instance, as described above, the computing system 120 may be configured to adjust one or more operational settings of the cotton harvester based on the amount of MOC contained within the harvester materials, such as an aggressiveness setting of the harvesting implement 30, 30*, an operational setting of one or more of the cleaning-related sub-systems of the harvester 10, 10*, the ground speed of the harvester 10, 10*, and/or the like. Additionally, in instances in which the computing system determines the effectiveness of the cleaning-related sub-system(s) of the harvester 10, 10 (e.g., based on post-cleaning and pre-cleaning data indicative of the amount of MOC contained within the harvested materials), the computing system 120 may be configured to select which operational setting(s) to adjust based on the determined effectiveness of the cleaning-related sub-system(s).

Referring now to FIG. 5, a flow diagram of another embodiment of a method 300 for automatically controlling the operation of a cotton harvester is illustrated in accordance with aspects of the present subject matter. For purposes of discussion, the method 300 will generally be described herein with reference to the harvester embodiments and system embodiments shown in FIGS. 1-3. However, it should be appreciated that the disclosed method 300 may be executed to control the operation of a cotton harvester having any other suitable harvesting configuration and/or in association with any suitable system having any other suitable system configuration. Additionally, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (302), the method 300 includes receiving an image(s) of harvested materials captured at a location along a material transfer path of a cotton harvester. For example, as indicated above, each quality sensor 104 may, in several embodiments, correspond to one or more imaging devices. In such an embodiments, the one or more imaging devices may be installed at one or more corresponding locations along the material transfer path defined through the material processing system 32, 32* of the cotton harvester 10, 10*. The images captured by the quality sensor(s) may then be transmitted to the computing system 120 for subsequent storage and/or processing.

Additionally, as shown in FIG. 5, at (304), the method 300 includes determining a quality-related metric associated with the harvested materials based at least in part on the image(s). Specifically, as indicated above, the computing system 120 may be configured to analyze the images received from the quality sensor(s) 104 using any suitable image processing algorithm and/or computer vision technique to determine or estimate one or more quality-related metrics, such as the amount of MOC contained within the harvested materials, the color of the harvested cotton, the presence of insect/fungal damage, the fiber thickness or micronaire of the cotton, and/or the like.

In addition, based on the type of quality-related metric being determined, the computing system 120 may also be configured to perform one or more control actions. For instance, as indicated above, when the quality-related metric is associated with the amount of MOC contained with the harvested materials or any other parameter that is impacted by the performance or operation of the harvester 10, 10*, the computing system 120 may be configured to automatically adjust the operation of the harvester 10, 10 to improve the quality-related metric. Moreover, the computing system 120 may also be configured to perform one or more additional control actions, such as: (1) logging or storing the data associated with the metric within its memory 124; (2) transmitting the data to a separate computing device (e.g., a remote sever or a client device); (3) geo-referencing the data to allow for quality mapping and/or subsequent bale/module correlation; (3) tagging or associating the data with a given bale/module; (5) and/or perform any other suitable control actions.

It is to be understood that the steps of the methods 200, 300 are performed by the computing system 120 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 120 described herein, such as the methods 200, 300, is implemented in software code or instructions which are tangibly stored on a tangible computer readable medium. The computing system 120 loads the software code or instructions via a direct interface with the computer readable medium or via a wired and/or wireless network. Upon loading and executing such software code or instructions by the computing system 120, the computing system 120 may perform any of the functionality of the computing system 120 described herein, including any steps of the methods 200, 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cotton harvester comprising:
a harvesting implement configured to harvest materials from a field, the harvested materials including both cotton and material other than cotton (MOC);
a material processing system configured to receive the harvested materials from the harvesting implement, the harvested materials being directed through the material processing system along a material transfer path;
a sensor configured to generate data indicative of an amount of MOC contained within the harvested materials at a location along the material transfer path; and
a computing system communicatively coupled to the sensor, the computing system being configured to adjust an operational setting of the cotton harvester based at least in part on the amount of MOC contained within the harvested materials.

2. The cotton harvester of claim 1, wherein the operational setting comprises an aggressiveness setting of the harvesting implement.

3. The cotton harvester of claim 1, wherein the material processing system comprises one or more cleaning-related sub-systems configured to remove MOC from the harvested materials.

4. The cotton harvester of claim 3, wherein:
the sensor is configured to generate data indicative of the amount of MOC contained within the harvested materials at a location downstream of at least a portion of the one or more cleaning related sub-systems along the material transfer path, and
the operational setting comprises an operational setting of at least one of the harvesting implement or the one or more cleaning sub-systems.

5. The cotton harvester of claim 3, wherein:
the sensor is configured to generate data indicative of the amount of MOC contained within the harvested materials at a location upstream of at least a portion of the one or more cleaning related sub-systems along the material transfer path, and
the operational setting comprises an operational setting of the harvesting implement.

6. The cotton harvester of claim 3, wherein:
the sensor comprises a first sensor configured to generate data indicative of the amount of MOC contained within the harvested materials at a location downstream of at least a portion of the one or more cleaning related sub-systems along the material transfer path,
the cotton harvester further comprises a second sensor communicatively coupled to the computing system, with the second sensor being configured to generate data indicative of the amount of MOC contained within the harvested materials at a location upstream of the at least a portion of the one or more cleaning related sub-systems along the material transfer path, and
the computing system is configured to determine an effectiveness of the one or more cleaning-related sub-systems based at least in part on the data received from the first and second sensors.

7. The cotton harvester of claim 6, wherein the computing system is configured to select the operational setting to be adjusted based at least in part on the determined effectiveness of the one or more cleaning-related sub-systems.

8. The cotton harvester of claim 3, wherein the one or more cleaning-related sub-systems comprise at least one of a pneumatic transport sub-system of the material processing system or an onboard cleaning assembly of the material processing system.

9. The cotton harvester of claim 1, wherein the sensor is further configured to generate data indicative of one or more additional quality-related metrics associated with the harvested materials beyond the amount of MOC contained within the harvested materials.

10. The cotton harvester of claim 1, further comprising a second sensor communicatively coupled to the computing system, the second sensor being configured to generate data indicative of an amount of cotton remaining within the field,
wherein the computing system is configured to adjust the operational setting of the cotton harvester based at least in part on the amount of MOC contained within the harvested materials and the amount of cotton remaining within the field.

11. A system for automatically controlling the operation of a cotton harvester, the system comprising:
a harvesting implement configured to harvest materials from a field;
a material processing system configured to receive the harvested materials from the harvesting implement, the harvested materials being directed through the material processing system along a material transfer path;
an imaging device configured to capture an image of the harvested materials at a location along the material transfer path; and
a computing system communicatively coupled to the imaging device, the computing system being configured to determine a quality-related metric associated with the harvested materials based at least in part on the captured image.

12. The system of claim 11, wherein the harvested materials include both cotton and material other than cotton (MOC), the quality-related metric being associated with an amount of MOC contained within the harvested materials.

13. The system of claim 11, wherein the computing system is further configured to adjust an operational setting of the cotton harvested based at least in part on the quality-related metric.

14. The system of claim 13, wherein the operational setting comprises an aggressiveness setting of the harvesting implement.

15. The system of claim 13, wherein:
the material processing system comprises one or more cleaning-related sub-systems configured to remove material other than cotton (MOC) from the harvested materials, and
the operational setting comprises an operational setting of at least one of the harvesting implement or the one or more cleaning-related sub-systems.

16. A method for automatically controlling the operation of a cotton harvester, the cotton harvester including a harvesting implement configured to harvest materials from a field, with the harvested materials including both cotton and material other than cotton (MOC), the method comprising:
receiving, with a computing system, data indicative of an amount of MOC contained within the harvested materials; and
adjusting, with the computing system, an operational setting of the cotton harvester based at least in part on the amount of MOC contained within the harvested materials.

17. The method of claim 16, wherein adjusting the operational setting of the cotton harvester comprises adjusting an aggressiveness setting of the harvesting implement based at least in part on the amount of MOC contained within the harvested materials.

18. The method of claim 16, wherein:
the cotton harvester further comprises a material processing system configured to receive the harvested materials from the harvesting implement, the harvested materials being directed through the material processing system along a material transfer path, and
receiving the data comprises received data indicative of the amount of MOC contained within the harvested materials at a location along the material transfer path.

19. The method of claim 18, wherein:
the material processing system further comprises one or more cleaning-related sub-systems configured to remove MOC from the harvested materials, and
adjusting the operational setting of the cotton harvester comprises adjusting an operational setting of at least one of the harvesting implement or the one or more cleaning-related sub-systems.

20. The method of claim 18, wherein:
receiving the data comprises receiving data indicative of the amount of MOC contained within the harvested materials at first and second locations along the material transfer path, the first location being positioned upstream of at least a portion of one or more cleaning sub-systems of the material processing system and the second location being positioned downstream of at the least a portion of the one or more cleaning sub-systems, and
determining an effectiveness of the one or more cleaning-related sub-systems based at least in part on the data indicative of the amount of MOC contained within the harvested materials at first and second locations along the material transfer path.
